(19) United States
(12) Patent Application Publication
(10) Pub. No.: US 2024/0377815 A1
(43) Pub. Date: Nov. 14, 2024

(54) DATA COLLECTION FREQUENCY DETERMINATION DEVICE AND DATA COLLECTION FREQUENCY DETERMINATION METHOD

(71) Applicant: DAIKIN INDUSTRIES, LTD., Osaka (JP)

(72) Inventors: Naomi SAKAI, Osaka (JP); Takayuki NAKAHARA, Osaka (JP)

(21) Appl. No.: 18/781,754

(22) Filed: Jul. 23, 2024

Related U.S. Application Data
(63) Continuation of application No. PCT/JP2023/003214, filed on Feb. 1, 2023.

(30) Foreign Application Priority Data
Feb. 8, 2022 (JP) 2022-017727

(51) Int. Cl. G05B 19/4155

(52) U.S. Cl. CPC G05B 19/4155; G05B 2219/32085

(57) ABSTRACT

A data collection frequency determination device determines a frequency of collecting data from a facility device in which tag information for identification is assigned for each item of the data that is necessary. The data collection frequency determination device includes an acquisition unit, a storage unit, and a determination unit. The acquisition unit acquires the tag information from the facility device. The storage unit stores the tag information and first information including a collection frequency for the data. The collection frequency for the data is associated with the tag information. The determination unit determines a collection frequency for the data based on the tag information acquired by the acquisition unit and the first information.

### CROSS-REFERENCE TO RELATED APPLICATIONS

This is a continuation of Application No. PCT/JP2022/003214 filed on Feb. 1, 2023, which claims priority to Japanese Patent Application No. 2022-017727, filed on Feb. 8, 2022. The entire disclosures of these applications are incorporated by reference herein.

### BACKGROUND

### Technical Field

The present disclosure relates to a data collection frequency determination device and a data collection frequency determination method for determining a frequency of collecting data from a facility device.

### Background Art

A monitoring control device that monitors and controls in a remote manner a facility such as an air conditioner acquires data that the facility is holding, using a communication method called polling. In general, data is acquired at equal intervals.

However, when polling is performed for all pieces of data at equal intervals, accuracy is lowered when there is a wide range of fluctuation in the data, and, on the other hand, unnecessary communication occurs when there is a narrow range of fluctuation in the data. Therefore, in a monitoring control device described in Japanese Unexamined Patent Application Publication No. 2013-187816, an optimal number of times of polling (a collection frequency for data) is manually set for a facility and for each item of data.

### SUMMARY

In the method described above, however, it is necessary to set a collection frequency for data for each of all facilities and for each of all items of data, which takes too many person-hours. Therefore, there is an issue of reducing person-hours for setting a collection frequency for data.

A data collection frequency determination device according to a first aspect is a data collection frequency determination device that determines a frequency of collecting data from a facility device in which tag information for identification is assigned for each item of the data that is necessary, and that includes an acquisition unit, a storage unit, and a determination unit. The acquisition unit acquires the tag information from the facility device. The storage unit stores the tag information and first information including a collection frequency for the data, the collection frequency for the data being associated with the tag information. The determination unit determines a collection frequency for the data based on the tag information acquired by the acquisition unit and the first information.

### BRIEF DESCRIPTION OF THE DRAWINGS

FIG. 1 is a schematic configuration diagram of a monitoring control system for a refrigeration apparatus, according to a first embodiment.

FIG. 2 is a block diagram illustrating schematic configurations of a monitoring control device and the refrigeration apparatus.

FIG. 3 is a table illustrating a collection frequency for data per hour for each of four types of data that the monitoring control device has acquired from the refrigeration apparatus at equal intervals.

FIG. 4 is a table illustrating results of optimizing the collection frequency for the data per hour in accordance with a magnitude of fluctuation in each of the four types of data illustrated in FIG. 3.

FIG. 5 is a flowchart for determining a collection frequency for data, according to the first embodiment.

FIG. 6 is a table illustrating an example of pieces of tag information, which are assigned to items of data.

FIG. 7 is a conceptual diagram of pieces of past data stored in a server.

FIG. 8 is a table illustrating requested collection frequencies determined by a central processing unit (CPU).

FIG. 9 is a flowchart for determining a collection frequency for data, according to a second embodiment.

FIG. 10 is a table illustrating an example of pieces of tag information, which are assigned to items of data.

FIG. 11 is a table illustrating degrees of priority, which are set for each tags.

FIG. 12 is a table illustrating degrees of priority and collection frequencies for data, which are determined by the CPU.

### DETAILED DESCRIPTION OF EMBODIMENT(S)

### First Embodiment

### (1) Schematic Configuration of Monitoring Control System 1 for Refrigeration Apparatus

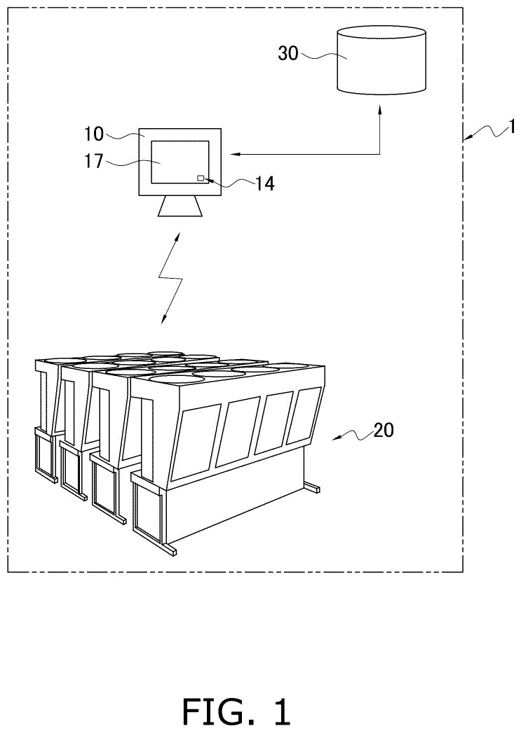

FIG. 1 is a schematic configuration diagram of a monitoring control system 1 for a refrigeration apparatus, according to a first embodiment. In FIG. 1, the monitoring control system 1 for the refrigeration apparatus includes a monitoring control device 10, a chiller 20 serving as the refrigeration apparatus, and a server 30. Information is transmitted and received between the monitoring control device 10 and the chiller 20 through wireless communication.

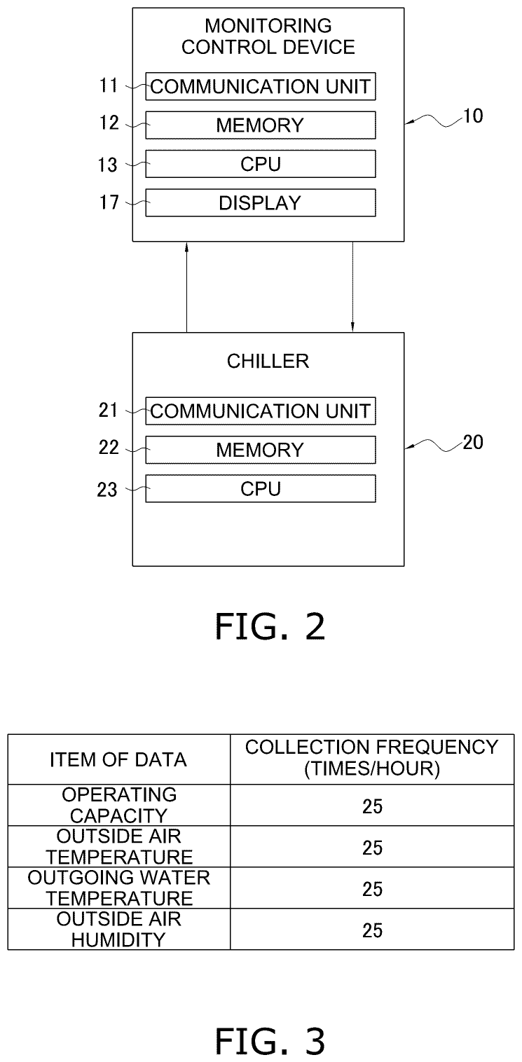

FIG. 2 is a block diagram illustrating schematic configurations of the monitoring control device 10 and the chiller 20. Furthermore, FIG. 2 mainly illustrates parts relating to functions of the monitoring control system 1 according to the present invention, and illustration of other detailed parts is omitted.

In FIG. 2, the monitoring control device 10 includes a communication unit 11, a memory 12, a CPU 13, and a display 17.

The CPU 13 processes information acquired through communication with the chiller 20, for example. The memory 12 stores information processed by the CPU 13 and information acquired by the CPU 13.

The display 17 is a screen that outputs read information or information inputted by a user, for example. A button 14 is displayed on the display 17, allowing the user to set and input predetermined information.

The chiller 20 includes a communication unit 21, a memory 22, and a CPU 23. The communication unit 21 transmits and receives information to and from the communication unit 11 in the monitoring control device 10. The CPU 23 processes information acquired via the communication unit 21 and information stored in the memory 22.

The memory 22 stores information processed by the CPU 23 and information acquired by the CPU 23 as setting information. Note that the setting information includes all types of information necessary for operating the chiller 20.

### (2) Monitoring Control Device 10

The monitoring control device 10 acquires data that the chiller 20 is holding, using a communication method called polling, to monitor and control the chiller 20. Although intervals at which data is acquired differ depending on communication specifications at a site, data is in general acquired at equal intervals.

FIG. 3 is a table illustrating a number of times of polling per hour for each of four types of data that the monitoring control device 10 has acquired from the chiller 20 at equal intervals. The number of times of polling per hour will be hereinafter referred to as a “collection frequency” for data.

In FIG. 3, the four types of data are “operating capacity”, “outside air temperature”, “outgoing water temperature”, and “outside air humidity”. As illustrated in FIG. 3, performing data collection for all pieces of data at equal intervals causes a decrease in accuracy to occur for data in which there is large fluctuation, and causes unnecessary communication to occur for data in which there is small fluctuation.

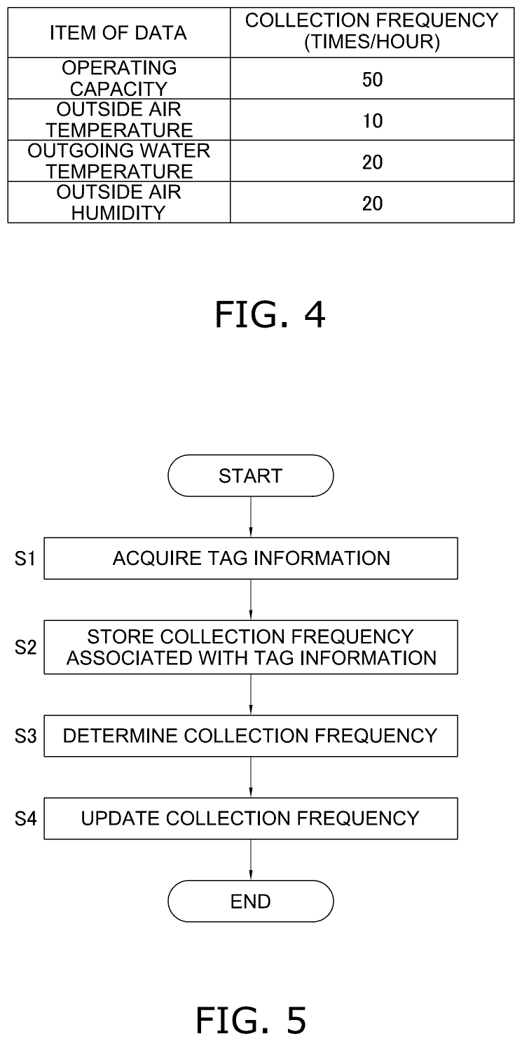

FIG. 4 is a table illustrating results of optimizing the collection frequency for the data in accordance with a magnitude of fluctuation in each of the four types of data illustrated in FIG. 3. Since there is a wide range of fluctuation in the data “operating capacity”, the collection frequency is set to 50 times in FIG. 4.

Since there is a narrower range of fluctuation in the data “outside air temperature” than each of the ranges of fluctuation in the other three types of data, on the other hand, the collection frequency is set to 10 times. Since the ranges of fluctuation in the data “outgoing water temperature” and the data “outside air humidity” are each wider than the range of fluctuation in the data “outside air temperature” and narrower than the range of fluctuation in the data “operating capacity”, the collection frequencies are each set to 20 times.

It is also possible to achieve such optimization as illustrated in FIG. 4 manually for each facility or each item of data serving as a target to be monitored by the monitoring control device 10. As facilities or items of data increase in number, however, person-hours increase.

The monitoring control device 10 according to the present embodiment is therefore configured to automatically determine a collection frequency for data from past records, and functions as a “data collection frequency determination device”.

### (2-1) Method for Determining Collection Frequency for Data

Tag information for identification is assigned to each item of data that is necessary in not only the chiller 20 according to the present embodiment, but also other facility devices. In the present embodiment, determining a collection frequency for data starts as the monitoring control device 10 acquires tag information from the chiller 20.

The “tag information” described in the present application is set separately from a name of data, and tags relating to substances such as water (#water) and air (#air), physical quantities such as temperature (#temperature) and pressure (#pressure), measurement locations such as outlet (#leaving) and inlet (#entering), and state information of a device such as operating capacity (#capacity) are determined in advance, providing information relating to a meaning of data (data relating to a target that has been measured and a location at which the target has been measured) by combining and assigning such tags.

Furthermore, although it is possible to infer a meaning of data to some extent from a name of the data, the name of the data is designated for each device (by each manufacturer), resulting in complication in determining similarity in name of data among different types of devices, as well as resulting in difficulty in reusing a collection frequency for the data.

For the “tag information” described in the present application, on the other hand, a necessary tag is assigned from predetermined tags to each piece of data relating to a device, resulting in easiness in determining similarity in tag information even when there is a slight difference among devices, as well as resulting in easiness in reusing a collection frequency for the data.

FIG. 5 is a flowchart for determining a collection frequency for data. Operation of determining a collection frequency for data by the monitoring control device 10 will now be described herein with reference to FIG. 5.

### Step S1

The CPU 13 acquires tag information assigned to each item of data that the chiller 20 is holding through communication with the chiller 20 via the communication unit 11.

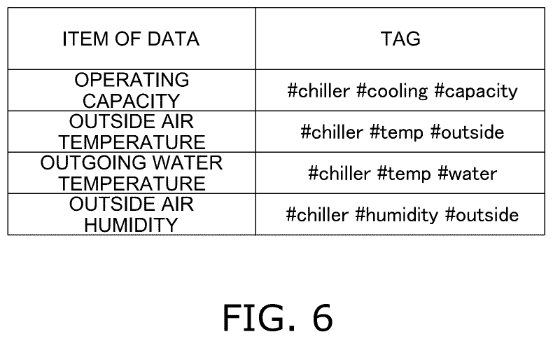

FIG. 6 is a table illustrating an example of pieces of tag information, which are assigned to items of data. For example, the item of the data “operating capacity”, the item of the data “outside air temperature”, the item of the data “outgoing water temperature”, and the item of the data “outside air humidity” are assigned with tags #chiller #cooling #capacity, tags #chiller #temp #outside, tags #chiller #temp #water, and tags #chiller #humidity #outside, respectively.

### Step S2

The CPU 13 acquires, from pieces of past data stored in the server 30, tag information that there is a match and a collection frequency for data, which is associated with the tag information, and temporarily stores the acquired information and collection frequency for data in the memory 12 as necessary information.

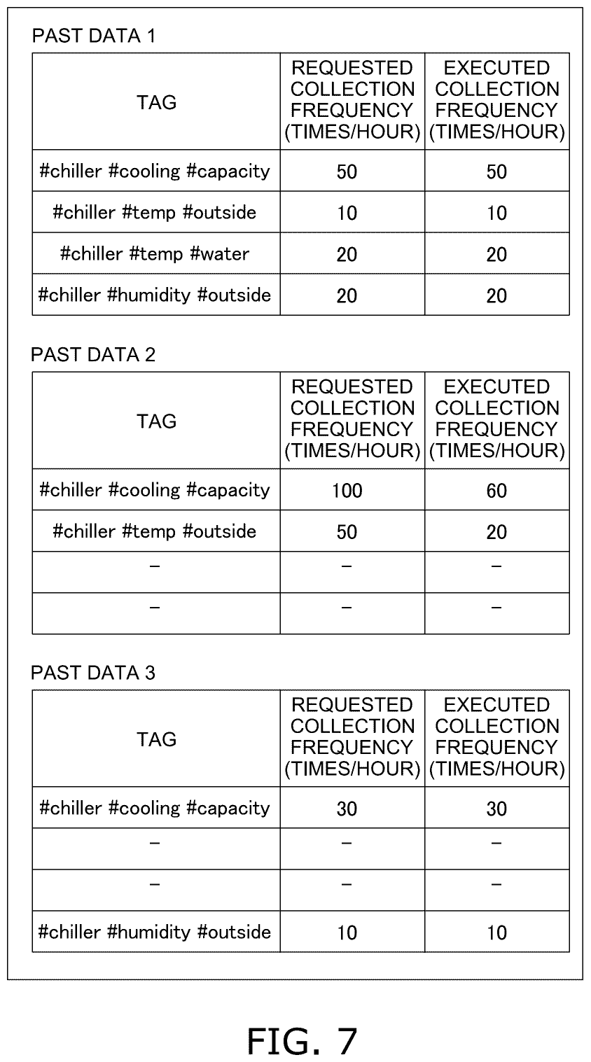

FIG. 7 is a conceptual diagram of the pieces of past data stored in the server 30. In FIG. 7, pieces of data corresponding to three records are stored, where, as can be seen in the past data [1] representing a most recent one (the data at the top in FIG. 7 in here), there is a record where a collection frequency as requested is 50 times and a collection frequency as executed is 50 times for the tags #chiller #cooling #capacity. In this case, it is understood that collection of the data has been performed at the collection frequency as requested. A collection frequency as requested will be hereinafter referred to as a “requested collection frequency”, and a collection frequency as executed will be hereinafter referred to as an “executed collection frequency”.

As can be seen in the past data [2] representing a second recent one, there is a record where a requested collection frequency is 100 times and an executed collection frequency is 60 times for the tags #chiller #cooling #capacity. In this case, it is understood that collection of the data has not been performed at the collection frequency as requested.

### Step S3

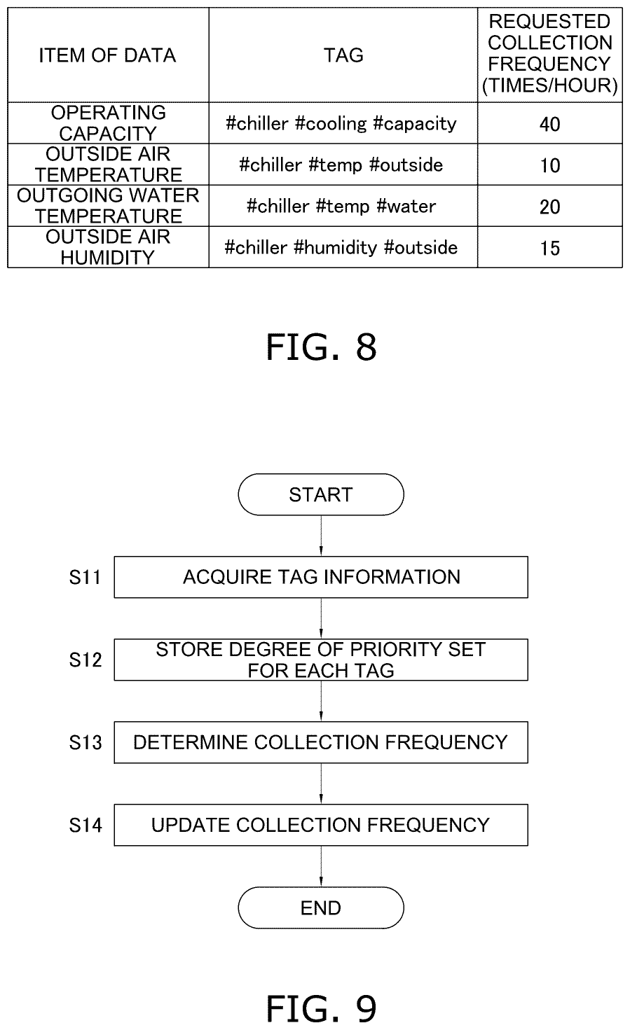

The CPU 13 determines a collection frequency for data based on the necessary information acquired in step S2. The CPU 13 acquires an average value of the collection frequencies from the three pieces of past data, and determines a collection frequency for data. FIG. 8 illustrates the requested collection frequencies determined by the CPU 13.

The collection frequency for the operating capacity (#chiller #cooling #capacity) is (50+30)/2=40. The collection frequency for the operating capacity (#chiller #cooling #capacity) in the past data [2], in which there has been a great difference between the requested collection frequency and the executed collection frequency, indicating that there may be a possibility that the collection frequency was set without taking into account a standard value for communication, has been removed by the CPU 13 as noise.

When an executed collection frequency has gone below a requested collection frequency even once, the executed collection frequency is removed as noise and is not used for calculation of a collection frequency, in the present embodiment. Therefore, the CPU 13 calculates an average value based on the collection frequencies in the past data [1] and the past data [3].

The collection frequency for the outside air temperature (#chiller #temp #outside) is 10. The collection frequency for the outside air temperature (#chiller #temp #outside) in the past data [2], in which there has been a great difference between the requested collection frequency of 50 and the executed collection frequency, has been removed by the CPU 13 as noise. Therefore, the CPU 13 makes a determination based only on the record of the outside air temperature (#chiller #temp #outside) in the past data [1].

The collection frequency for the outgoing water temperature (#chiller #temp #water) is 20. Since only the record of the outgoing water temperature (#chiller #temp #water) in the past data [1] exists, the CPU 13 makes a determination based on the record.

The collection frequency for the outside air humidity (#chiller #humidity #outside) is (20+10)/2=15. Since the collection frequencies for the outside air humidity (#chiller #humidity #outside) exist as records in the past data [1] and the past data [3], the CPU 13 calculates an average value based on these two collection frequencies.

The CPU 13 is able to output and display the collection frequencies for the data, which have been determined, on the display 17 of the monitoring control device 10. However, the collection frequencies for the data, which are displayed on the display 17, are only shown as candidates at this point in time, and are not set unless an operator of the monitoring control device 10 presses the button 14 for setting and inputting on the display 17 for confirmation.

Furthermore, when a standard value for communication exists for a collection frequency for data and a set value exceeds the standard value, or when there is a great deviation between the set value and an actual value of the collection frequency, the CPU 13 excludes the set value. Note herein that the term “exclude the set value” means that the set value is not accepted even when the set value is determined as the button 14 on the display 17 is pressed, or even when the set value is accepted, the set value is removed as noise when a next collection frequency is calculated.

### Step S4

The CPU 13 updates the necessary information in the memory 12 to allow the collection frequencies for data, which have been determined, to be associated with the tag information assigned to the items of the data. Specifically, when the operator of the monitoring control device 10 confirms the collection frequencies for the data, which are displayed on the display 17, and presses the button 14 on the display 17, the necessary information in the memory 12 is updated and stored in the server 30 as data to be utilized later.

Since a frequency at which the monitoring control device 10 collects data from the chiller 20 is automatically determined based on a collection frequency for data, which is associated with tag information, as described above, person-hours for setting a collection frequency for data are reduced.

Although, in the present embodiment, a requested collection frequency is determined based on an average value of pieces of past data, the present invention is not limited to the present embodiment. For example, a collection frequency may be determined, based on a mode value or a median value of collection frequencies, from pieces of past data.

### (3) Feature

### (3-1)

Since, in the monitoring control device 10, a frequency of collecting data from a facility device such as the chiller 20 is automatically determined based on a collection frequency for data, which is associated with tag information, person-hours for setting a collection frequency for data are reduced.

### (3-2)

In the monitoring control device 10, even when there are a plurality of facility devices serving as targets of monitoring control, the memory 12 stores tag information assigned to each item of data relating to each of the plurality of facility devices and a collection frequency for the data, which is associated with the tag information. A frequency of collecting data is then automatically determined for each of the plurality of facility devices based on the collection frequency for the data, which is associated with the tag information, and person-hours for setting a collection frequency for data are reduced.

### 3-3)

Even when a plurality of collection frequencies for data are associated with tag information in the monitoring control device 10, the CPU 13 determines a collection frequency for the data based on an average value, allowing the operator to proceed with a task without doubt.

### 3-4)

In the monitoring control device 10, the CPU 13 causes the display 17 of the monitoring control device 10 to display a collection frequency for data, which has been determined, as a candidate that is selectable by the operator.

### 3-5)

The operator confirms the collection frequency for the data, which is displayed on the display 17, and presses the button 14 on the display 17 in the monitoring control device 10. As a result, the necessary information in the memory 12 is updated to allow the collection frequency for the data to be associated with the tag information assigned to the item of the data, and the updated information is stored in the server 30. As a result, the collection frequency for the data is optimized.

### 3-6)

When a plurality of collection frequencies that have been set previously are associated with tag information, and a collection frequency is determined by averaging the collection frequencies, in the monitoring control device 10, it is impossible to derive an optimal collection frequency, when past set values exceeding a standard value or deviating from the standard value are also included. Excluding them makes it therefore possible to achieve a highly-optimal collection frequency.

### (4) Modification Examples

Although the description has been provided so far on the premise that, it is assumed that tag information acquired from the chiller 20 matches tag information stored as past data, tag information assigned to a facility device may be different depending on a manufacturer or a person who has inputted the tag information.

By taking into account such a situation, in a monitoring control device 10 according to a modification example, it is possible to select a candidate from similar tag information when there is no tag information achieving a perfect match in past data.

When tag information acquired from a certain facility device includes #chiller #temp #outside #air, for example, a candidate is selected from #chiller #temp #outside, where there are similarities, since there is no tag information achieving a match in past data.

### Second Embodiment

An embodiment in which no past data is to be acquired will now be described herein as a second embodiment. In a monitoring control device 10 according to the second embodiment, a method using a degree of priority that is set for each tag is adopted.

Tags used for water temperature, air temperature, air pressure, water pressure, flow rate, and air volume, which are physical quantities frequently used in the chiller 20, are #water, #air, #temp, #pressure, and #flow. Degrees of priority are set in advance for these tags and stored in the server 30.

When tag information that the monitoring control device 10 has acquired from the chiller 20 includes “#temp #outside”, a physical quantity relating to the tag information is a temperature of air, and thus the tags to be used are #air and #temp.

When the degrees of priority for #air and #temp are 1 and 2, respectively, a degree of priority for “#temp #outside” is expressed as a product of the degrees of priority, which are set in the tags of the physical quantities, that is, 1×2=2. In the second embodiment, a degree of priority for each piece of tag information is acquired with this procedure, and a collection frequency for data is determined based on the degree of priority.

FIG. 9 is a flowchart for determining a collection frequency for data, according to the second embodiment. Hereinafter, operation of determining a collection frequency for data by the monitoring control device 10 will be described with reference to FIG. 9.

### Step S11

The CPU 13 acquires tag information assigned to each item of data that the chiller 20 is holding through communication with the chiller 20 via the communication unit 11.

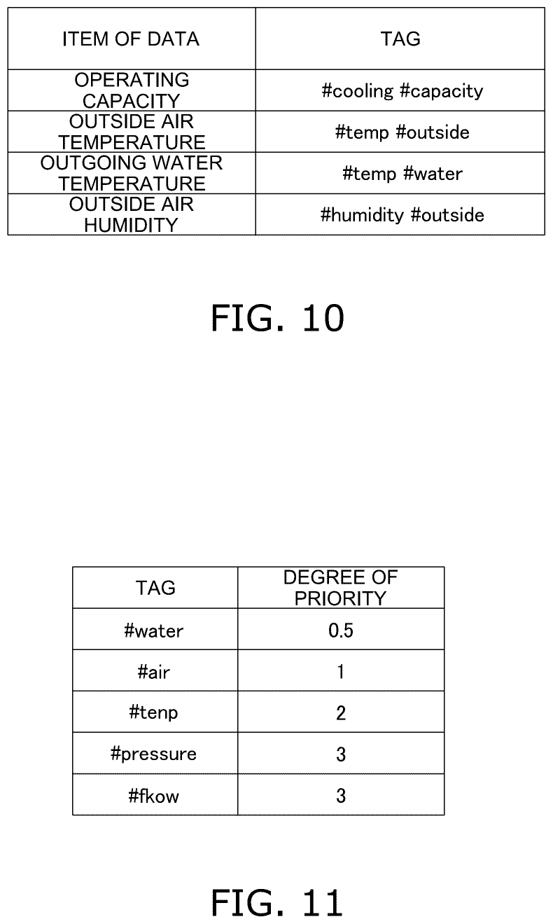

FIG. 10 is a table illustrating an example of pieces of tag information, which are assigned to items of data. For example, the item of the data “operating capacity”, the item of the data “outside air temperature”, the item of the data “outgoing water temperature”, and the item of the data “outside air humidity” are assigned with the tag information “#cooling #capacity”, the tag information “#temp #outside”, the tag information “#temp #water”, and the tag information “#humidity #outside”, respectively.

### Step S12

The CPU 13 acquires, from the server 30, the tags indicating the physical quantities and the degrees of priority, which are set respectively to the tags, and temporarily stores the tags and degrees of priority in the memory 12 as necessary information.

FIG. 11 is a table illustrating the degrees of priority, which are set for the tags. In FIG. 11, the degrees of priority of 0.5, 1, 2, 3, and 3 are set to #water, #air, #temp, #pressure, and #flow, respectively.

### Step S13

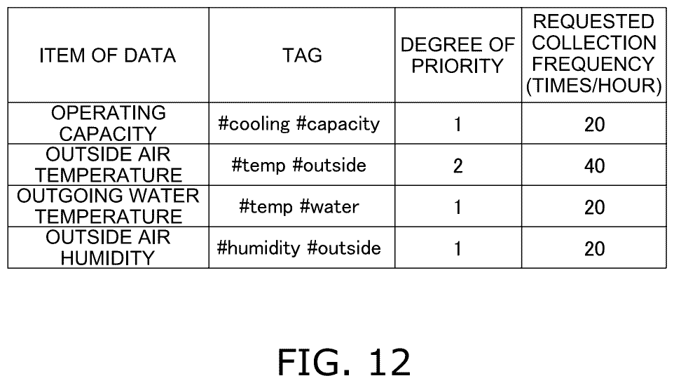

The CPU 13 determines a collection frequency for data based on the necessary information acquired in step S2. The CPU 13 identifies a tag of a relating physical quantity from the tags in the tag information, and determines a collection frequency for data based on a value acquired by performing a multiplication with the degree of priority set to the tag of the physical quantity. FIG. 12 is a table illustrating degrees of priority and collection frequencies for data, which are determined by the CPU 13.

A tag corresponding to a physical quantity relating to the operating capacity (#cooling #capacity) does not exist in the server 30. In such a case, its degree of priority is set to 1 based on an agreement in advance.

A physical quantity relating to the outside air temperature (#temp #outside) is a temperature of air, and the tags are #air and #temp. Since the degrees of priority for #air and #temp are 1 and 2, respectively, a degree of priority for the outside air temperature (#temp #outside) is 1×2=2.

A physical quantity relating to the outgoing water temperature (#temp #water) is a temperature of water, and the tags are #water and #temp. Since the degrees of priority for #water and #temp are 0.5 and 2, respectively, a degree of priority for the outgoing water temperature (#temp #water) is 0.5×2=1.

A tag corresponding to a physical quantity relating to the outside air humidity (#humidity #outside) does not exist in the server 30. In such a case, its degree of priority is set to 1 based on an agreement in advance.

Since, in the present embodiment, a maximum collection frequency for data is 100 times, the CPU 13 calculates a collection frequency for data from a ratio of a degree of priority for each item of data with respect to a total value of the degrees of priority for “operating capacity”, “outside air temperature”, “outgoing water temperature”, and “outside air humidity”.

The operating capacity (#cooling #capacity) is 100×1/(1+2+1+1)=20 times. The outside air temperature (#temp #outside) is 100×2/(1+2+1+1)=40 times. The outgoing water temperature (#temp #water) is 100×1/(1+2+1+1)=20 times. The outside air humidity (#humidity #outside) is 100×1/(1+2+1+1)=20 times.

The CPU 13 is able to output and display the collection frequencies for the data, which have been determined, on the display 17 of the monitoring control device 10. However, the collection frequencies for the data, which are displayed on the display 17, are only shown as candidates at this point in time, and are not set unless the operator of the monitoring control device 10 presses the button 14 on the display 17 for confirmation.

### Step S14

The CPU 13 updates the necessary information in the memory 12 to allow the degrees of priority for the tags used for the newly set physical quantities to be stored. Specifically, since the degree of priority “1”, which has been agreed for #capacity and #humidity for which no relating physical quantities exist, and the collection frequencies for the data, which have been determined, are displayed on the display 17, the operator of the monitoring control device 10 confirms them and presses the button 14 on the display 17, allowing the necessary information in the memory 12 to be updated and to be stored in the server 30.

Preferably, it is recommended that the necessary information in the memory 12 be updated to allow not only the degrees of priority, but also the collection frequencies for the data, which have been determined, to be associated with the tag information assigned to the items of the data, and that the updated information be stored in the server 30 as data.

Since a frequency at which the monitoring control device 10 collects data from the chiller 20 is automatically determined based on a degree of priority associated with tag information, person-hours for setting a collection frequency for data are reduced, as described above.

### Other Embodiments

In the first embodiment, a collection frequency for data has been determined based on a collection frequency for data, which is associated with tag information acquired from a facility device (the chiller 20). Furthermore, in the second embodiment, a degree of priority has been acquired based on tag information acquired from a facility device, and a collection frequency for data has been determined based on the degree of priority.

However, the method for determining a collection frequency for data is not limited to the two methods described above. For example, it may be possible to adopt such a configuration of executing a first step of acquiring tag information from a facility device, a second step of storing the tag information and necessary information in which a collection frequency for data is determined in advance for each piece of tag information, and a third step of determining a collection frequency for data based on the tag information acquired in the first step and the necessary information.

Since a frequency of collecting data from a facility device is automatically determined based on a collection frequency for the data, which is determined in advance for each piece of tag information, person-hours for setting a collection frequency for data are reduced.

While the embodiments of the present disclosure have been described above, it will be understood that various changes in form and detail may be made therein without departing from the spirit and scope of the present disclosure as set forth in the appended claims.

Although, in the present disclosure, the chiller has been described as an application example, the present disclosure is not limited to the chiller, and is generally applied to facility devices that collect data.

1. A data collection frequency determination device configured to determine a frequency of collecting data from a facility device in which tag information for identification is assigned for each item of the data that is necessary, the data collection frequency determination device comprising:
an acquisition unit configured to acquire the tag information from the facility device;
a storage unit that stores the tag information and first information including a collection frequency for the data, the collection frequency for the data being associated with the tag information; and
a determination unit configured to determine a collection frequency for the data based on the tag information acquired by the acquisition unit and the first information.

2. The data collection frequency determination device according to claim 1, wherein
the first information includes the tag information assigned to each item of the data relating to each of a plurality of the facility devices and a collection frequency for the data, the collection frequency for the data being associated with the tag information.

3. The data collection frequency determination device according to claim 1, wherein,
when a plurality of pieces of the first information are associated with the tag information, the determination unit is configured to determine a collection frequency for the data based on a predetermined condition.

4. The data collection frequency determination device according to claim 1, wherein
the determination unit is configured to output determined candidates for the first information.

5. The data collection frequency determination device according to claim 1, further comprising:
a setting unit configured to set the collection frequency for the data,
the setting unit being configured to update the first information by setting the collection frequency for the data, the collection frequency for the data being determined, to be associated with the tag information assigned to the item of the data.

6. The data collection frequency determination device according to claim 5, wherein,
when a standard value for communication exists for the collection frequency for the data and a set value for the collection frequency exceeds the standard value, or when there is a predetermined deviation between the set value and an actual value of the collection frequency,
the determination unit is configured to exclude the set value.

7. The data collection frequency determination device according to claim 2, wherein,
when a plurality of pieces of the first information are associated with the tag information, the determination unit is configured to determine a collection frequency for the data based on a predetermined condition.

8. The data collection frequency determination device according to claim 2, wherein
the determination unit is configured to output determined candidates for the first information.

9. The data collection frequency determination device according to claim 2, further comprising:
a setting unit configured to set the collection frequency for the data,
the setting unit being configured to update the first information by setting the collection frequency for the data, the collection frequency for the data being determined, to be associated with the tag information assigned to the item of the data.

10. The data collection frequency determination device according to claim 3, wherein
the determination unit is configured to output determined candidates for the first information.

11. The data collection frequency determination device according to claim 3, further comprising:
a setting unit configured to set the collection frequency for the data,
the setting unit being configured to update the first information by setting the collection frequency for the data, the collection frequency for the data being determined, to be associated with the tag information assigned to the item of the data.

12. A data collection frequency determination device configured to determine a frequency of collecting data from a facility device in which tag information for identification is assigned for each item of the data that is necessary, the data collection frequency determination device comprising:
an acquisition unit configured to acquire the tag information from the facility device;
a storage unit that stores the tag information and second information in which a collection frequency for the data is determined in advance for each piece of the tag information; and
a determination unit configured to determine a collection frequency for the data based on the tag information acquired by the acquisition unit and the second information.

13. A data collection frequency determination device configured to determine a frequency of collecting data from a facility device in which tag information for identification is assigned for each item of the data that is necessary, the data collection frequency determination device comprising:
an acquisition unit configured to acquire the tag information from the facility device;
a storage unit that stores the tag information and third information in which a degree of priority for a collection frequency for the data is determined in advance for each piece of the tag information; and
a determination unit configured to determine a collection frequency for the data based on the tag information acquired by the acquisition unit and the third information.

14. The data collection frequency determination device according to claim 13, further comprising:
a setting unit configured to set a collection frequency for the data,
when a desired collection frequency for the data has been set, the setting unit being configured to update the third information by setting the collection frequency for the data, the collection frequency for the data being set, to be associated with the tag information assigned to the data.

15. A data collection frequency determination method to determine a frequency of collecting data from a facility device in which tag information for identification is assigned for each item of the data that is necessary, the data collection frequency determination method including:
acquiring the tag information from the facility device;
storing the tag information and first information including a collection frequency for the data, the collection frequency for the data being associated with the tag information; and
determining a collection frequency for the data based on the tag information acquired in the first step and the first information.

16. A data collection frequency determination method to determine a frequency of collecting data from a facility device in which tag information for identification is assigned for each item of the data that is necessary, the data collection frequency determination method including:
acquiring the tag information from the facility device;
storing the tag information and second information in which a collection frequency for the data is determined in advance for each piece of the tag information; and
determining a collection frequency for the data based on the tag information acquired in the first step and the second information.

17. A data collection frequency determination method to determine a frequency of collecting data from a facility device in which tag information for identification is assigned for each item of the data that is necessary, the data collection frequency determination method including:
acquiring the tag information from the facility device;
storing the tag information and third information in which a degree of priority for a collection frequency for the data is determined in advance for each piece of the tag information; and
determining a collection frequency for the data based on the tag information acquired in the first step and the third information.
